(19) United States
(12) Patent Application Publication
(10) Pub. No.: US 2007/0149060 A1
(43) Pub. Date: Jun. 28, 2007

(54) Reducing signal crosstalk of edge-card connector

(76) Inventor: Xiaoning Ye, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/319,915

(22) Filed: Dec. 27, 2005

(51) Int. Cl. H01R 24/00

(52) U.S. Cl. 439/637

(57) ABSTRACT

In some embodiments an edge-card connector includes a signal layer, a ground layer, an edge finger, a ground plane on the ground layer that is recessed a portion of the edge finger, and a ground section on the signal layer that is coupled to the ground plane. Other embodiments are described and claimed.

### TECHNICAL FIELD

The inventions generally relate to reducing signal crosstalk of an edge-card connector.

### BACKGROUND

In personal computers current programs and data that are in use are stored in system memory. The system memory holds the instructions that the processor executes and also holds the data that those instructions work with. System memory is often referred to as simply “memory”. System memory is an important part of the main processing subsystem of the computer, and is typically coupled with the processor, cache, motherboard, and chipset, for example. Memory connectors are used to couple a memory, memory board, and/or memory module to a board, bus, and/or other device, for example, in a computer system. Some memory connectors are edge-card connectors.

The signal integrity performance for an edge-card connector (for example, a memory connector such as a DDRII/FBD/FBD2 connector) (Double Data Rate II/Fully Buffered Dual In-line Memory Module (DIMM)/Fully Buffered DIMM 2 connector) is typically measured by two key factors including insertion loss and crosstalk. Maintaining a low insertion loss and a low crosstalk is getting more challenging as the signaling bit rate continues to increase and reaches (and exceeds) multi-gigabit-per-second speeds.

One approach that may be used to lower insertion loss of an edge-card connector is to recess the ground plane beneath the edge finger (for example, the edge finger of a DIMM (Dual In-line Memory Module) board). Such an approach reduces excessive capacitance between the edge finger and the ground plane and therefore improves the insertion loss. However, this approach creates an additional problem in that it increases the signal crosstalk between the primary side and the secondary side of the connector. Therefore, a need has arisen for an edge-card connector arrangement that reduces crosstalk while also maintaining insertion loss for memory connectors that are edge-card connectors and also for other edge-card connectors that are not memory connectors.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates an edge-card connector 100 according to some embodiments of the inventions.

FIG. 2 illustrates an edge-card connector 200 according to some embodiments of the inventions.

FIG. 3A illustrates an edge-card connector 300A according to some embodiments of the inventions.

FIG. 3B illustrates an edge-card connector 300B according to some embodiments of the inventions.

FIG. 3C illustrates an edge-card connector 300C according to some embodiments of the inventions.

FIG. 4 illustrates a graph 400 showing insertion loss according to some embodiments of the inventions.

FIG. 5 illustrates a graph 500 showing near-end crosstalk (NEXT) according to some embodiments of the inventions.

FIG. 6 illustrates a graph 600 showing far-end crosstalk (FEXT) according to some embodiments of the inventions.

### DETAILED DESCRIPTION

Some embodiments of the inventions relate to reducing signal crosstalk of an edge-card connector.

Some embodiments of the inventions relate to reducing signal crosstalk of a memory connector.

In some embodiments an edge-card connector includes a signal layer, a ground layer, an edge finger, a ground plane on the ground layer that is recessed a portion of the edge finger, and a ground section on the signal layer that is coupled to the ground plane.

In some embodiments a system includes a processor, a memory, and a memory connector. The memory connector includes a signal layer, a ground layer, an edge finger, a ground plane on the ground layer that is recessed a portion of the edge finger, and a ground section on the signal layer that is coupled to the ground plane.

In some embodiments a ground plane on a ground layer of an edge-card connector is recessed by a portion of an edge finger of the edge-card connector, and a ground section on a signal layer of the edge-card connector is coupled to the recessed ground plane.

According to some embodiments signal crosstalk of an edge-card connector (for example, a memory connector) is reduced. For example, signal crosstalk between the primary side and the secondary side of an edge card connector (for example, a memory connector) is reduced. In some embodiments, signal crosstalk is reduced between the primary side and the secondary side of a DDRII (Double Data Rate II), a FBD (Fully Buffered Dual In-line Memory Module), and/or an FBD2 memory connector. According to some embodiments, benefits include improved signal integrity, no additional cost, and/or improved functionality.

According to some embodiments, a stack-up is provided that significantly reduces crosstalk between the primary side and the secondary side of an edge-card connector (for example, a memory connector), while maintaining an insertion loss that is achieved by recessing the ground plane. This can be accomplished in a relatively easy manner without any additional cost.

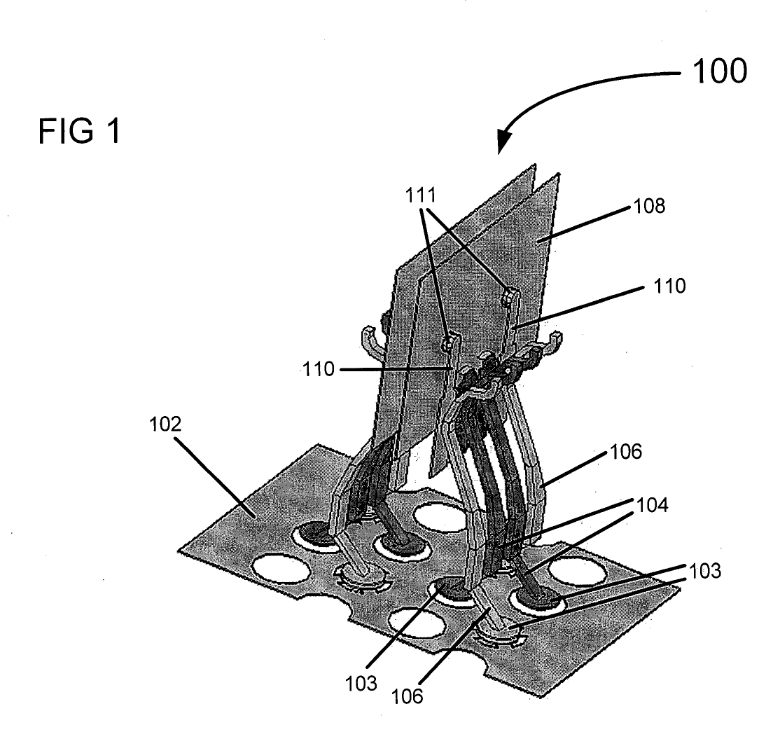

FIG. 1 illustrates an edge-card connector 100 according to some embodiments (for example, a memory connector such as a DDRII/FBD/FBD2 connector). Edge-card connector 100 is soldered to a board 102 (for example, a Printed Circuit Board such as a motherboard of a computer system). Vias 103 are pushed through board 102 and then soldered onto board 102 to electrically connect signal pins 104 and ground pins 106 of edge-card connector 100 to board 102. Board 102 and vias 103 are not typically included in the edge-card connector 100. Edge-card connector 100 includes, among other elements, signal pins 104, ground pins 106, ground plane 108, edge fingers 110, and ground vias 111. It is noted that one side (for example, the primary side) of edge-card connector 100 is numbered in FIG. 1, but that portions of another side (for example, a secondary side) are illustrated in FIG. 1, but not referenced in order to focus on certain elements of the edge-card connector 100. Additionally, for further and better illustration purposes, not all elements of edge-card connector 100 are illustrated. For example, the dielectrics and printed circuit boards (PCBs) of the edge-card connector 100 are not illustrated.

The signal to ground ratio of the edge-card connector 100 illustrated in FIG. 1 is 2:1 (see, for example, where the signal pins 104 and the ground pins 106 are located). In a PCI-express connector design (not illustrated) it is noted that a similar (but not the same) edge finger connector is used. In a PCI-express connector it has been shown that recessing a ground plane on an edge-card reduces the insertion loss. However, for an edge-card connector (for example, edge-card connector 100) such as a DDRII/FBD/FBD2 connector, for example, recessing the ground plane (for example, ground plane 108) can create another issue such that crosstalk between the primary side of the edge-card connector and the secondary side of the edge-card connector increases. (It is noted that a PCI-express connector does not have this problem because the signal to ground ratio is 1:1, and any signal pin pair on one side of the connector will always face a pair of ground pins on the other side of the connector). It is also worth noting that when the ground plane of an edge-card connector such as DDRII/FBD/FBD2 is not recessed, it provides shielding between the differential signal pair on the primary/secondary side of the connector and reduces crosstalk. One approach to solving the crosstalk problem discussed herein is to recess the ground plane approximately one half of the length of the edge finger so that the connector has a “medium” performance of both insertion loss and crosstalk. However, this solution is not perfect, since it has neither optimal insertion loss performance nor optimal crosstalk performance.

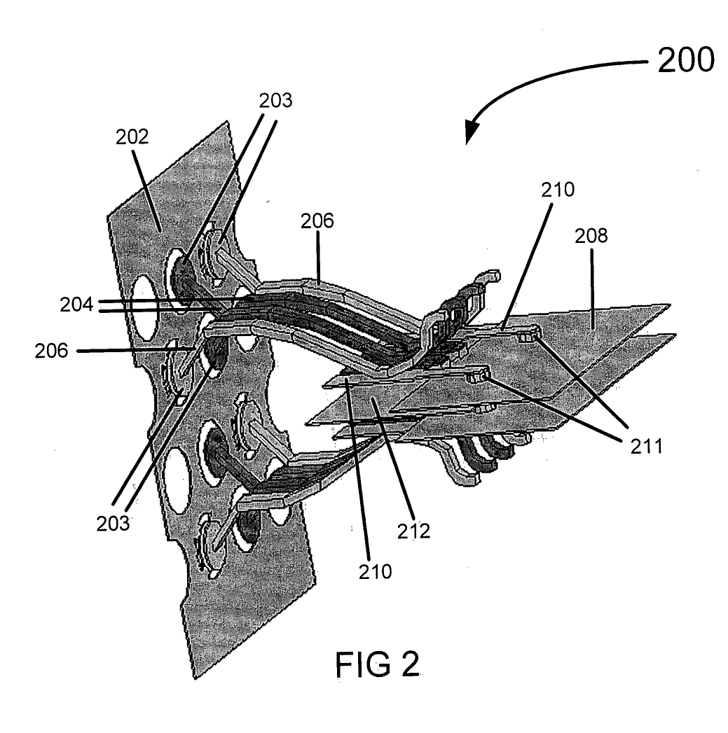

FIG. 2 illustrates an edge-card connector 200 according to some embodiments (for example, a memory connector such as a DDRII/FBD/FBD2 connector). Edge-card connector 200 is soldered to a board 202 (for example, a Printed Circuit Board such as a motherboard of a computer system). Vias 203 are pushed through board 202 and then soldered onto board 202 to electrically connect signal pins 204 and ground pins 206 of edge-card connector 100 to board 102. Board 202 and vias 203 are not typically included in the edge-card connector 200. Edge-card connector 200 includes, among other elements, signal pins 204, ground pins 206, ground plane 208, edge fingers 210, ground vias 211, and a small section of metal plane 212. It is noted that one side (for example, the primary side) of edge-card connector 100 is numbered in FIG. 2, but that portions of another side (for example, a secondary side) are illustrated in FIG. 2, but not referenced in order to focus on certain elements of the edge-card connector 200. Additionally, for further and better illustration purposes, not all elements of edge-card connector 200 are illustrated. For example, the dielectrics and printed circuit boards (PCBs) of the edge-card connector 200 are not illustrated.

As illustrated in FIG. 2, the ground plane 208 (on the ground layer) is recessed to the approximately the full length of the edge finger 210 for optimal insertion loss performance. In addition the small section of metal plane (or “ground section”) 212 is located on the signal layer. The section of metal plane 212 is connected (shorted) to the large ground plane 208 on the ground layer using ground vias 211. The ground vias 211 are also shorted to the ground pins 206 of the connector 200. The purpose of this ground section 212 is to “shield” the crosstalk between the primary side and the secondary side of the edge-card connector 200. Since the ground section 212 is on the signal layer (which is further away from the edge finger 210 than the ground layer) the impact on insertion loss performance is much smaller.

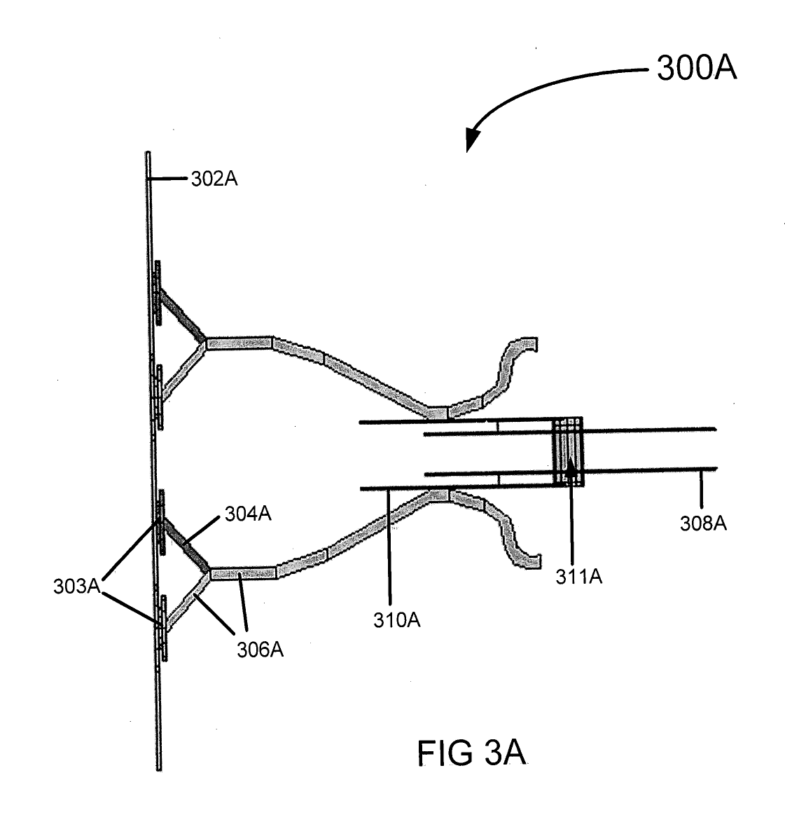

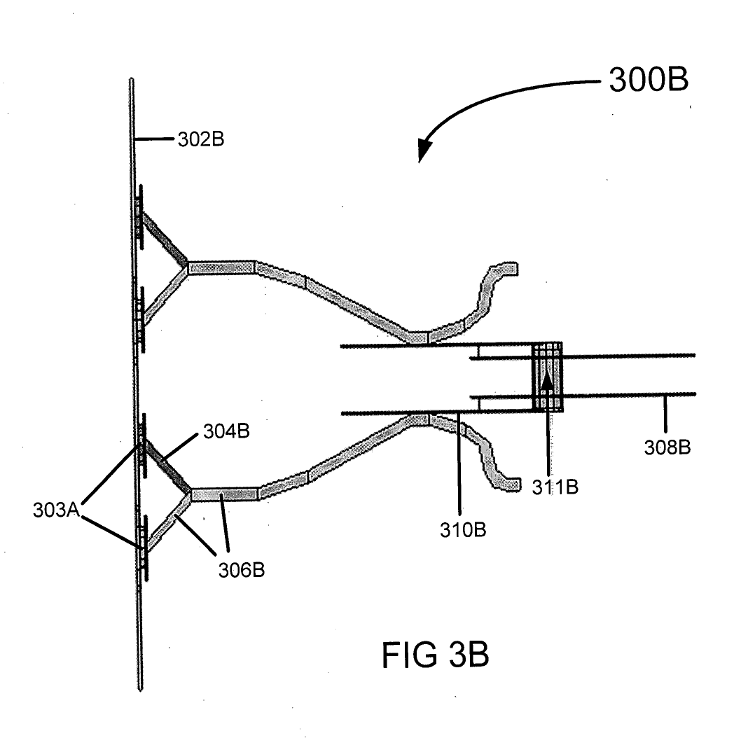

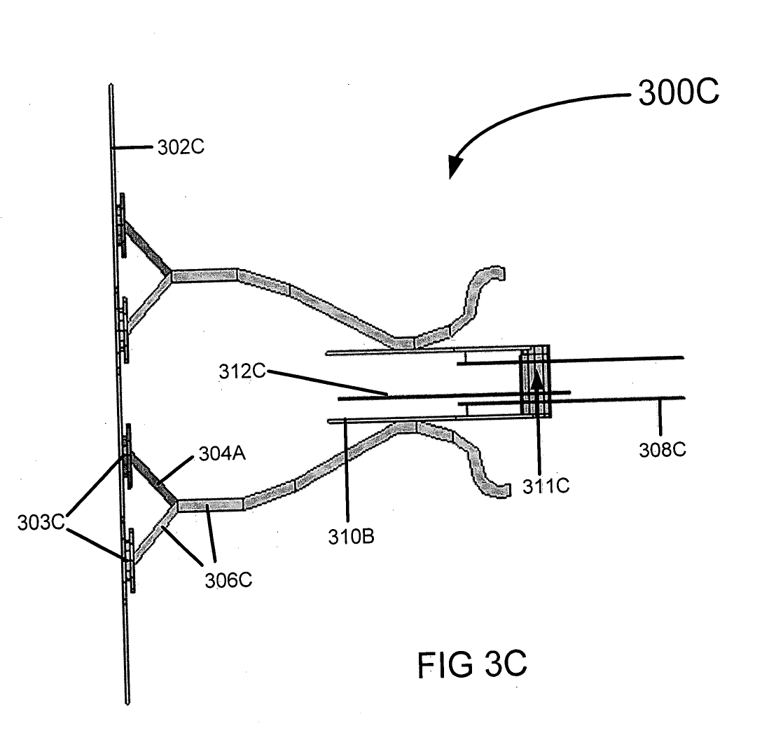

FIG. 3A illustrates a edge-card connector 300A according to some embodiments (for example, a memory connector such as a DDRII/FBD/FBD2 connector). Edge-card connector 300A is soldered to a board 302A (for example, a Printed Circuit Board such as a motherboard of a computer system). Vias 303A are pushed through board 302A and then soldered onto board 302A to electrically connect signal pins 304A and ground pins 306A of edge-card connector 300 to board 302A. Board 302A and vias 303A are not typically included in the edge-card connector 300A. Edge-card connector 300A includes, among other elements, signal pins 304A, ground pins 306A, ground plane 308A, edge fingers 310A, and ground vias 311A. It is noted that one side (for example, the primary side) of edge-card connector 300A is numbered in FIG. 3A, but that portions of another side (for example, a secondary side) are illustrated in FIG. 3A, but not referenced in order to focus on certain elements of the edge-card connector 300A. Additionally, for further and better illustration purposes, not all elements of edge-card connector 300A are illustrated. For example, the dielectrics and printed circuit boards (PCBs) of the edge-card connector 300A are not illustrated. The ground plane 308A of edge-card connector 300A is “half recessed”. That is, ground plane 308A is recessed approximately one half the length of the edge fingers 310A.

FIG. 3B illustrates an edge-card connector 300B according to some embodiments (for example, a memory connector such as a DDRII/FBD/FBD2 connector). Edge-card connector 300B is soldered to a board 302B (for example, a Printed Circuit Board such as a motherboard of a computer system). Vias 303B are pushed through board 302B and then soldered onto board 302B to electrically connect signal pins 304B and ground pins 306B of edge-card connector 300B to board 302B. Board 302B and vias 303B are not typically included in the edge-card connector 300B. Edge-card connector 300B includes, among other elements, signal pins 304B, ground pins 306B, ground plane 308B, edge fingers 310B, and ground vias 311B. It is noted that one side (for example, the primary side) of edge-card connector 300B is numbered in FIG. 3B, but that portions of another side (for example, a secondary side) are illustrated in FIG. 3B, but not referenced in order to focus on certain elements of the edge-card connector 300B. Additionally, for further and better illustration purposes, not all elements of edge-card connector 300B are illustrated. For example, the dielectrics and printed circuit boards (PCBS) of the edge-card connector 300B are not illustrated. The ground plane 308B of edge-card connector 300B is “fully recessed”. That is, ground plane 308B is recessed approximately the entire length of the edge fingers 310B.

FIG. 3C illustrates an edge-card connector 300C according to some embodiments (for example, a memory connector such as a DDRII/FBD/FBD2 connector). Edge-card connector 300C is soldered to a board 302C (for example, a Printed Circuit Board such as a motherboard of a computer system). Vias 303C are pushed through board 302C and then soldered onto board 302C to electrically connect signal pins 304C and ground pins 306C of edge-card connector 300C to board 302C. Board 302C and vias 303C are not typically included in the edge-card connector 300C. Edge-card connector 300C includes, among other elements, signal pins 304C, ground pins 306C, ground plane 308C, edge fingers 310C, ground vias 311C and a small section of metal plane (and/or “section of plane” and/or “ground section”) 312C. It is noted that one side (for example, the primary side) of edge-card connector 300C is numbered in FIG. 3C, but that portions of another side (for example, a secondary side) are illustrated in FIG. 3C, but not referenced in order to focus on certain elements of the edge-card connector 300C. Additionally, for further and better illustration purposes, not all elements of edge-card connector 300C are illustrated. For example, the dielectrics and printed circuit boards (PCBs) of the edge-card connector 300C are not illustrated.

The ground plane 308C of edge-card connector 300C is “fully recessed”. That is, ground plane 308C is recessed approximately the entire length of the edge fingers 310C (for example, for optimal insertion loss performance). In addition, the small section of metal plane 312C is located on the signal layer. The section of metal plane 312C is connected (shorted) to the large ground plane 308C on the ground layer using ground vias 311C. The ground vias 311C are also shorted to the ground pins 306C of the connector 300C. The purpose of this ground section 312C is to “shield” the crosstalk between the primary side and the secondary side of the edge-card connector 300C. Since the ground section 312C is on the signal layer (which is further away from the edge finger 310C than the ground layer) the impact on insertion loss performance is much smaller.

Although one ground section (for example, ground section 212 in FIG. 2 and ground section 312C in FIG. 3C) has been shown according to some embodiments, according to some embodiments another ground section is included in another signal layer (for example, on the other primary or secondary side) to ensure copper balancing, for example.

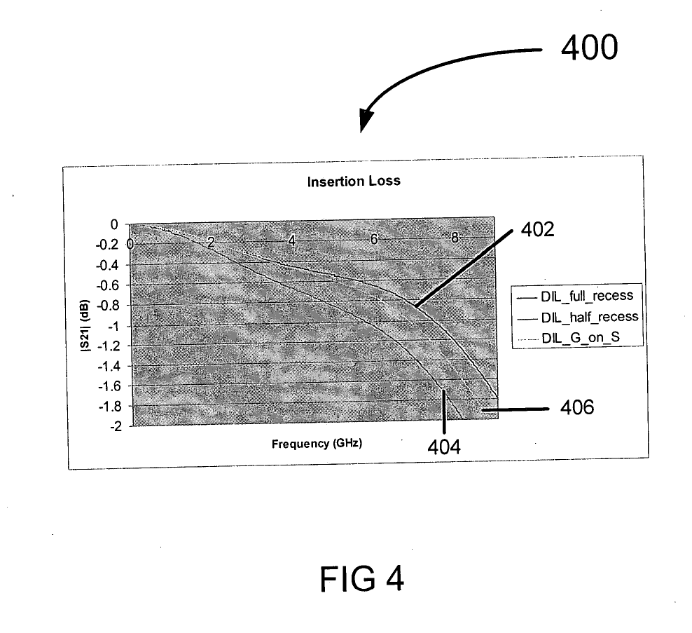

FIG. 4 illustrates a graph 400 showing insertion loss (for example, differential insertion loss or “DIL”) for some edge-card connectors having three different geometries according to some embodiments. Graph 400 includes insertion loss graph 402 for an edge-card connector having fully recessed ground plane (for example, an edge-card connector such as edge-card connector 300A in FIG. 3A), insertion loss graph 404 for an edge-card connector having a half-recessed ground plane (for example, an edge-card connector such as edge-card connector 300B in FIG. 3B), and insertion loss graph 406 for an edge-card connector having a ground segment on the signal layer (for example, an edge-card connector such as edge-card connector 300C in FIG. 3C). As illustrated in FIG. 4, the fully recessed ground plane edge-card connector has the best insertion loss (402), but the edge-card connector having the ground segment on the signal layer (406) has close to optimal insertion loss performance and is very similar to 402, particularly at frequencies of up to 4 GHz. This insertion loss 406 is shown for a ground segment on the signal layer for the bottom layer differential pair as illustrated in FIG. 3C, for example, and may be even better for implementations with ground segment on the signal layer for both the top and bottom layers of the differential pair.

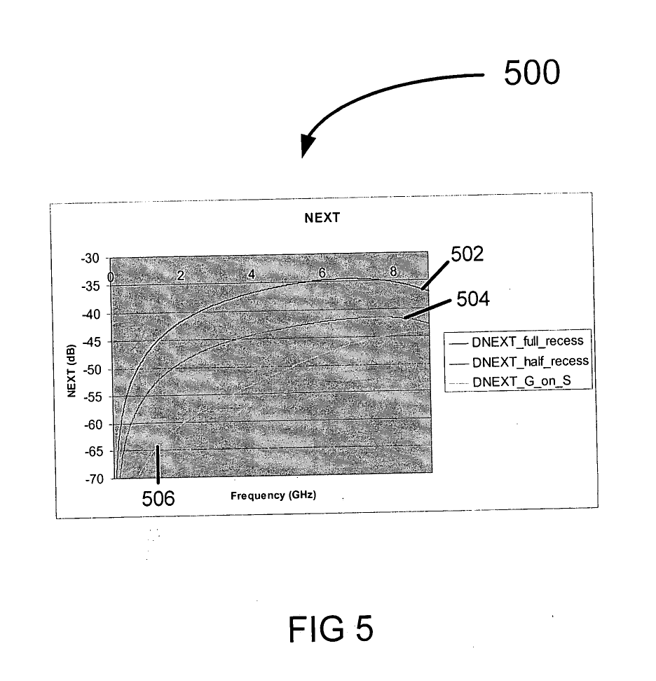

FIG. 5 illustrates a graph 500 showing near-end crosstalk (NEXT) for some edge-card connectors having three different geometries according to some embodiments. Graph 500 includes near-end crosstalk graph 502 for an edge-card connector having fully recessed ground plane (for example, an edge-card connector such as edge-card connector 300A in FIG. 3A), near-end crosstalk graph 504 for an edge-card connector having a half-recessed ground plane (for example, an edge-card connector such as edge-card connector 300B in FIG. 3B), and near-end crosstalk graph 506 for an edge-card connector having a ground segment on the signal layer (for example, an edge-card connector such as edge-card connector 300C in FIG. 3C). The graph 506 for the edge-card connector having a ground segment on the signal layer has significantly less near-end crosstalk compared with the other two geometries shown in graphs 502 and 504.

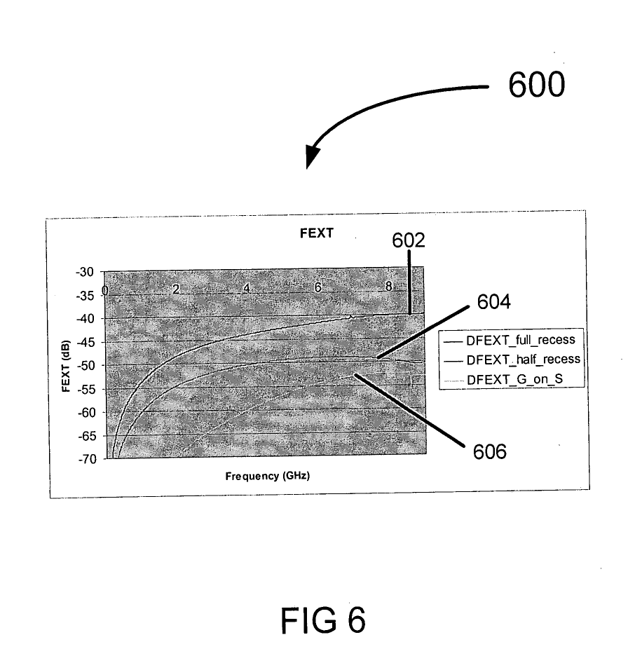

FIG. 6 illustrates a graph 600 showing far-end crosstalk (FEXT) for edge-card connectors having three different geometries according to some embodiments. Graph 600 includes insertion loss graph 602 for an edge-card connector having fully recessed ground plane (for example, an edge-card connector such as edge-card connector 300A in FIG. 3A), insertion loss graph 604 for an edge-card connector having a half-recessed ground plane (for example, an edge-card connector such as edge-card connector 300B in FIG. 3B), and insertion loss graph 606 for an edge-card connector having a ground segment on the signal layer (for example, an edge-card connector such as edge-card connector 300C in FIG. 3C). The graph 606 for the edge-card connector having a ground segment on the signal layer has significantly less far-end crosstalk compared with the other two geometries shown in graphs 602 and 604.

According to some embodiments an edge-card connector having a ground segment on the signal layer (for example, as illustrated in FIG. 2 and/or FIG. 3C) can potentially increase eye opening of the link at the receiver by tens of milivolts (mv).

According to some embodiments an edge-card connector (for example, a memory connector) of 6 and/or more than 6 stack-ups may include a ground segment on the signal layer. According to some embodiments the layer stack up includes power planes at the internal layer, and the power planes can be fully extended to function as a “shield” for reducing side-to-side crosstalk.

According to some embodiments, an edge-card connector (for example, a memory connector) including a ground segment on the signal layer can significantly reduce crosstalk between a primary side and a secondary side of the edge-card connector. According to some embodiments, an improved signal quality can be obtained without any additional cost. According to some embodiments, high speed signals (for example, FBD/FBD2) can be routed at a longer length without adding cost.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1. An edge-card connector comprising:
a signal layer;
a ground layer;
an edge finger;
a ground plane on the ground layer that is recessed a portion of the edge finger; and
a ground section on the signal layer that is coupled to the ground plane.

2. The edge-card connector of claim 1, wherein the edge-card connector is a memory connector.

3. The edge-card connector of claim 1, wherein the ground section is to shield a crosstalk of the edge-card connector.

4. The edge-card connector of claim 3, wherein the ground section is to shield a crosstalk between a primary side and a secondary side of the edge-card connector.

5. The edge-card connector of claim 1, wherein the ground plane is recessed an entire portion of the edge finger.

6. The edge-card connector of claim 1, wherein the ground plane is recessed a half portion of the edge finger.

7. The edge-card connector of claim 2, wherein the memory connector is a Double Data Rate II connector.

8. The edge-card connector of claim 2, wherein the memory connector is a Fully Buffered Dual In-line Memory Module connector.

9. The edge-card connector of claim 2, wherein the memory connector is a Fully Buffered Dual In-line Memory Module 2 connector.

10. The edge-card connector of claim 1, further comprising a primary side of the edge-card connector, wherein the signal layer, the ground layer, the edge finger, the ground plane, and the ground section are all included on the primary side of the edge-card connector.

11. The edge-card connector of claim 10, further comprising a secondary side of the edge-card connector, the secondary side including:
a second signal layer;
a second ground layer;
a second edge finger;
a second ground plane on the second ground layer that is recessed a portion of the second edge finger; and
a second ground section on the second signal layer that is coupled to the second ground plane.

12. A system comprising:
a processor;
a memory; and
a memory connector coupling the memory directly or indirectly to the processor, the memory connector including:
a signal layer;
a ground layer;
an edge finger;
a ground plane on the ground layer that is recessed a portion of the edge finger; and
a ground section on the signal layer that is coupled to the ground plane.

13. The system of claim 12, wherein the ground section is to shield a crosstalk of the memory connector.

14. The system of claim 13, wherein the ground section is to shield a crosstalk between a primary side and a secondary side of the memory connector.

15. The system of claim 12, wherein the ground plane is recessed the entire portion of the edge finger.

16. The system of claim 12, wherein the ground plane is recessed a half portion of the edge finger.

17. The system of claim 12, wherein the memory includes Double Data Rate II memory and the memory connector is a Double Data Rate II connector.

18. The system of claim 12, wherein the memory includes a Fully Buffered Dual In-line Memory Module and the memory connector is a Fully Buffered Dual In-line Memory Module connector.

19. The system of claim 12, wherein the memory includes a Fully Buffered Dual In-line Memory Module 2 and the memory connector is a Fully Buffered Dual In-line Memory Module 2 connector.

20. The system of claim 12, further comprising a primary side of the memory connector, wherein the signal layer, the ground layer, the edge finger, the ground plane, and the ground section are all included on the primary side of the memory connector.

21. The system of claim 20, further comprising a secondary side of the memory connector, the secondary side including:
a second signal layer;
a second ground layer;
a second edge finger;
a second ground plane on the second ground layer that is recessed a portion of the second edge finger; and
a second ground section on the second signal layer that is coupled to the second ground plane.

22. The system of claim 12, wherein the memory includes a Dual In-line Memory Module.

23. A method comprising:
recessing a ground plane on a ground layer of an edge-card connector a portion of an edge finger of the edge-card connector; and
coupling a ground section on a signal layer of the edge-card connector to the recessed ground plane.

24. The method of claim 23, wherein the edge-card connector is a memory connector.

25. The method of claim 23, further comprising shielding a crosstalk of the edge-card connector using the ground section.

26. The method of claim 23, further comprising:
recessing a second ground plane on a second ground layer of a secondary side of the edge-card connector by a portion of a second edge finger of the secondary side; and
coupling a second ground section on a second signal layer of the secondary side to the second recessed ground plane.

27. The method of claim 24, wherein the memory connector is a Double Data Rate II connector.

28. The method of claim 24, wherein the memory connector is a Fully Buffered Dual In-line Memory Module connector.

29. The method of claim 28, wherein the memory connector is a Fully Buffered Dual In-line Memory Module 2 connector.

30. The edge-card connector of claim 1, wherein the ground section on the signal layer is further away from the edge finger than the ground layer.

31. The system of claim 12, wherein the ground section on the signal layer is further away from the edge finger than the ground layer.

32. The method of claim 23, wherein the ground section on the signal layer is further away from the edge finger than the ground layer.
